(19) United States
(12) Patent Application Publication
(10) Pub. No.: US 2023/0290332 A1
(43) Pub. Date: Sep. 14, 2023

(54) SYSTEM AND METHOD FOR AUTOMATICALLY GENERATING SYNTHETIC HEAD VIDEOS USING A MACHINE LEARNING MODEL

(71) Applicant: International Institute of Information Technology, Hyderabad, Hyderabad (IN)

(72) Inventors: C.V. Jawahar, Hyderabad (IN); Aditya Agarwal, Jaipur (IN); Bipasha Sen, Navi Mumbai (IN); Rudrabha Mukhopadhyay, Hyderabad (IN); Vinay Namboodiri, Hydrabad (IN)

(21) Appl. No.: 18/120,375

(22) Filed: Mar. 11, 2023

(30) Foreign Application Priority Data
Mar. 11, 2022 (IN) 202241013438

(51) Int. Cl. G10L 13/027; G10L 25/57; G10L 25/63

(52) U.S. Cl. CPC G10L 13/027; G10L 25/57; G10L 25/63

(57) ABSTRACT

Embodiments herein provide a system and a method for automatically generating at least one synthetic talking head video using a machine learning model. The method includes (i) extracting features from each frame of a video that is extracted from data sources, (ii) analyzing, using a face-detection model, the video to determine a driving face video if a number of identities, and faces of speakers are equal to one in all frames of the video, (iii) generating, using a text to speech model, synthetic speech utterances by automatically selecting a vocabulary of words and sentences from the data sources, (iv) modifying lip movements that are originally present in the driving face video corresponding to the synthetic speech utterances, and (v) generating, using machine learning model, synthetic talking head video based on the lip movements that are modified corresponding to the synthetic speech utterances.

### CROSS-REFERENCE TO RELATED APPLICATIONS

This patent application claims priority to Indian provisional patent application no. 202241013438 filed on Mar. 11, 2022, the complete disclosures of which, in their entirety, are hereby incorporated by reference.

### BACKGROUND

### Technical Field

Embodiments of this disclosure generally relate to generating synthetic lip-reading videos, and more particularly, to a system and method for automatically generating synthetic talking head videos using a machine learning model for any languages and accents with real-world variations.

### Description of the Related Art

Lip reading is used extensively by hard-of-hearing- or hearing-impaired people as an essential mode of communication, that allows listening to a speaker by watching the speaker's face to figure out their speech patterns, movements, gestures, and expressions. And the lip-reading is especially important for those who have lost their hearing after the acquisition of speech and language skills.

People with any type of hearing loss solely rely upon their ability to recognize speech and words through the lip-reading as they have trouble understanding and hearing speech. Even though sign language is adopted by some people with hearing loss, the lip-reading is a primary mode of communication for those whose communication is needed and who cannot sign. Further, training people with hearing loss for lip reading is extremely challenging with limited resources. Even the Covid-19 pandemic has exacerbated and amplified this problem by limiting interaction and communications with speech therapists.

Existing lip-reading training platforms are limited by the vocabulary, including a lower number of speaker-specific real-world variations, and are mostly limited by a lower number of languages and accents. The existing platforms are specifically made for international languages and accents like the English language with accents including American, Australian, British, Scottish, Canadian, and the like, and do not provide solutions for local languages and accents. Those types of platforms may not support users whose language and accent differ from the language and accent provided in the existing platforms. Extending such lipreading training platforms to local languages and accents may require considerable cost and effort due to the technique followed by such platforms of manually recording and annotating each new video.

Accordingly, there remains a need to address the aforementioned technical drawbacks in existing technologies to generate synthetic talking head videos accurately.

### SUMMARY

In view of the foregoing, an embodiment herein provides a method for automatically generating at least one synthetic talking head video using a machine learning model. The method includes extracting at least one feature from each frame of at least one video that is extracted from at least one data source. The method includes analysing, using a face-detection model, the at least one feature to determine a driving face video if a number of identities, and faces of speakers are equal to one in all frames of the at least one video, the driving face video is a video that includes the number of identities, and the faces of speakers as one in each frame. The method includes generating, using a text to speech model, synthetic speech utterances by automatically selecting a vocabulary of words and sentences from the at least one data source. The method includes modifying lip movements of the single speaker that are originally present in the driving face video corresponding to the synthetic speech utterances. The method includes generating, using the machine learning model, at least one synthetic talking head video based on the lip movements that are modified corresponding to the synthetic speech utterances.

In some embodiments, the lip movements are modified by (i) detecting mouth movements from the at least one feature of the at least one video, (ii) aligning each synthetic speech utterance with a region in the driving face video with the mouth movements to determine an aligned utterance, (iii) padding the aligned utterance with a silence region of the input speech, and (iv) unchanging regions in the driving face video if the mouth movements are zero in all frames of the driving face video.

In some embodiments, the method further includes generating a synthetic talking head videos database based on the at least one synthetic talking head video that is generated.

In some embodiments, the method further includes detecting lip-landmarks and a rate of change of the lip-landmarks between a predefined threshold of frames to detect the mouth movements in the at least one video.

In some embodiments, the method further includes training a user in lip reading using the synthetic talking head videos database includes (i) the lip reading on isolated words, (ii) the lip reading on missing words in sentences, and (iii) the lip reading on the sentences with a context.

In some embodiments, the at least one feature includes at least one of faces of speakers, head-pose of speaker, back ground, back ground variations, speaker's distance from a camera, lip structures, the lip movements, poses, head movements, camera variations, number of identities, speaker's complexion from a plurality of videos.

In some embodiments, the method further includes training the text to speech model to generate the synthetic speech utterances by (i) obtaining the vocabulary of the words and the sentences that are selected from the at least one of data source, (ii) converting the words and the sentences from the vocabulary to a sequence of sounds, and (iii) adding, using a variance adaptor, a duration, pitch, and energy in to the sequence of speech sounds to obtain the synthetic speech utterances.

In some embodiments, the method further includes detecting, using the face-detection model, the single speaker in the driving face video by (i) tiling a plurality of boxes on each frame of the at least one video with different scales and aspect ratios, (ii) generating a plurality of anchors based on the plurality of boxes that are tiled on each frame of the at least one video, each anchor represents a location of the single speaker, a shape of the single speaker, and a size of the single speaker, and (iii) classifying, using the face detection model, the plurality of anchors by correlating with a series of pre-set anchors to detect the single speaker.

In some embodiments, discarding the at least one video if the face detection model detects multiple speakers or without speakers in the at least one video.

In some embodiments, the method further includes retaining the background, the camera variations, and the head movements that correspond to the at least one video when the at least one synthetic head video is generated.

In some embodiments, the method further includes training the machine learning model using historical driving face videos, historical native accents, historical non-native accents, and historical synthetic speech utterances.

In one aspect, there is provided one or more non-transitory computer-readable storage medium storing the one or more sequence of instructions, which when executed by the one or more processors, causes to perform a method for automatically generating at least one synthetic talking head video using a machine learning model. The method includes extracting at least one feature from each frame of at least one video that is extracted from at least one data source. The method includes analysing, using a face-detection model, the at least one feature to determine a driving face video if a number of identities, and faces of speakers are equal to one in all frames of the at least one video, the driving face video is a video that includes the number of identities, and the faces of speakers as one in each frame. The method includes generating, using a text to speech model, synthetic speech utterances by automatically selecting a vocabulary of words and sentences from the at least one data source. The method includes modifying lip movements of the single speaker that are originally present in the driving face video corresponding to the synthetic speech utterances. The method includes generating, using the machine learning model, at least one synthetic talking head video based on the lip movements that are modified corresponding to the synthetic speech utterances.

In another aspect, there is provided a system for automatically generating at least one synthetic talking head video using a machine learning model. The system includes a memory that stores a database and a set of modules, a processor in communication with the memory. The processor retrieves executing machine-readable program instructions from the memory which, when executed by the processor, enable the processor to (i) extract at least one feature from each frame of at least one video that is extracted from at least one data source, (ii) analyze, using a face-detection model, the at least one feature to determine a driving face video if a number of identities, and faces of speakers are equal to one in all frames of the at least one video, the driving face video is a video that includes the number of identities, and the faces of speakers as one in each frame, (iii) generate, using a text to speech model, synthetic speech utterances by automatically selecting a vocabulary of words and sentences from the at least one data source, (iv) modify lip movements that are originally present in the driving face video corresponding to the synthetic speech utterances, (v) generate, using the machine learning model, at least one synthetic talking head video based on the lip movements that are modified corresponding to the synthetic speech utterances.

In some embodiments, the lip movements are modified by (i) detecting mouth movements from the at least one feature of the at least one video, (ii) aligning each synthetic speech utterance with a region in the driving face video with the mouth movements to determine an aligned utterance, (iii) padding the aligned utterance with a silence region of the input speech, and (iv) unchanging regions in the driving face video if the mouth movements are zero in all frames of the driving face video.

In some embodiments, the processor is configured to generate a synthetic talking head videos database based on the at least one synthetic talking head video that is generated.

In some embodiments, the processor is configured to detect lip-landmarks and a rate of change of the lip-landmarks between a predefined threshold of frames to detect the mouth movements in the at least one video.

In some embodiments, the processor is configured to train a user in lip reading using the synthetic talking head videos database comprises (i) the lip reading on isolated words, (ii) the lip reading missing words in sentences, and (iii) the lip reading the sentences with a context.

In some embodiments, the at least one feature includes at least one of faces of speakers, head-pose of speaker, back ground, back ground variations, speaker's distance from a camera, lip structures, the lip movements, poses, head movements, camera variations, number of identities, speaker's complexion from a plurality of videos.

In some embodiments, the processor is configured to train the text to speech model to generate the synthetic speech utterances by (i) obtaining the vocabulary of the words and the sentences that are selected from the at least one of data source, (ii) converting the words and the sentences from the vocabulary to a sequence of sounds, and (iii) adding, using a variance adaptor, a duration, pitch, and energy in to the sequence of speech sounds to obtain the synthetic speech utterances.

In some embodiments, the processor is configured to detect, using the face-detection model, the single speaker in the driving face video by (i) tiling a plurality of boxes on each frame of the at least one video with different scales and aspect ratios, (ii) generating a plurality of anchors based on the plurality of boxes that are tiled on each frame of the at least one video, each anchor represents a location of the single speaker, a shape of the single speaker, and a size of the single speaker, and (iii) classifying, using the face detection model, the plurality of anchors by correlating with a series of pre-set anchors to detect the single speaker.

The system improves the user's ability to lip-read due to the variations in the speaker identity, lip shapes, larger vocabulary and the like. The system enables the users from all over the world to learn lip reading in their preferred language and accent with multiple examples for the same vocabulary words and sentences with real-world variations.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a system for automatically generating synthetic talking head videos using a machine learning model according to some embodiments herein;

FIG. 2 is a block diagram of a server of FIG. 1 according to some embodiments herein;

FIG. 3 is an exemplary flow diagram of a method for training a user to lip-read using a synthetic talking head videos database according to some embodiments herein; and

FIG. 4 is an exemplary representation of an original video, a misaligned synthetic talking head video, and an aligned synthetic talking head video according to some embodiments herein;

FIGS. 5A-5C are graphical representations of a comparison of scores of users by implementing various lipreading methods according to some embodiments herein;

FIG. 6 is a flow diagram that illustrates a method for automatically generating synthetic talking head videos using a machine learning model according to some embodiments herein; and

FIG. 7 is a schematic diagram of a computer architecture in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

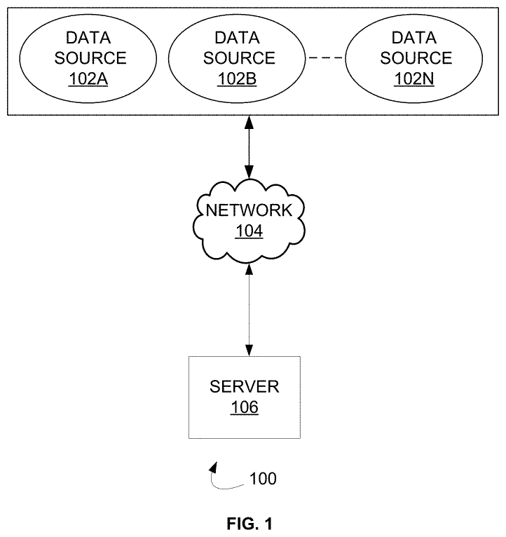

As mentioned, there remains a need for a system and a method for automatically generating synthetic talking head videos using a machine learning model. Referring now to the drawings, and more particularly to FIGS. 1 through 7, where similar reference characters denote corresponding features consistently throughout the figures, there are shown preferred embodiments.

FIG. 1 is a block diagram that illustrates a system 100 for automatically generating synthetic talking head videos using a machine learning model according to some embodiments herein. The system 100 includes data sources 102A-N, and a server 106. The data sources 102A-N extract one or more videos. The data sources 102A-N are configured to provide videos to the server 106 through network 104. The data sources 102A-N may extract the one or more videos from the internet. The one or more videos may include talking/interaction videos, youtube videos, streaming videos, movie videos, and the like. The server 106 includes memory that stores a database and a set of modules and a device processor that executes the set of modules. In some embodiments, the network 104 includes, but is not limited to, a wireless network, a wired network, a combination of the wired network and the wireless network, or the Internet and the like.

The server 106 extracts features from the extracted video. The features include at least one of the faces of speakers, head-pose of the speaker, background, background variations, speaker's distance from a camera, lip structures, the lip movements, poses, head movements, camera variations, number of identities, speaker's complexion from a plurality of videos.

The server 106 analyzes the video to determine a driving face video if a number of identities, and faces of speakers are equal to one in all frames of the at least one video using a face-detection model. The driving face video is a video that includes the number of identities, and the faces of speakers as one in each frame. The one or more driving face videos may include real-world variations in speaker identity. In some embodiments, the real-world variations in the speaker's identity include any of a complexion, a gender, an age, a pose, an accent, and the like. In some embodiments, the variations in the speaker's identity include the slang of the speaker. The slang of the speaker may be based on languages of the one or more videos. In some embodiments, the server 106 includes separate storage to store the one or more driving face videos based on the language.

The server 106 is configured to detect the single speaker in the driving face video by tiling a plurality of boxes on each frame of the at least one video with different scales and aspect ratios on each frame of the at least one video. The plurality of anchors is generated based on the plurality of boxes that are tiled on each frame of the at least one video. Each anchor represents a location of the single speaker, a shape of the single speaker, and a size of the single speaker. The plurality of anchors are classified using the face detection model. The face detection model classifies the plurality of anchors by correlating with a series of pre-set anchors to detect the single speaker. The server 106 discards the video if the face detection model detects multiple speakers or without speakers in the video.

The server 106 is configured to generate synthetic speech utterances by automatically selecting a vocabulary of words and sentences from the one or more data sources 102A-N using a text to speech model. The vocabulary of words and sentences may be manually entered before training the users.

In some embodiments, the server 106 is configured to train the text to speech model to generate the synthetic speech utterances by (i) obtaining the vocabulary of the words and the sentences that are selected from the data sources 102A-N, (ii) converting the words and the sentences from the vocabulary to a sequence of sounds, and (iii) adding, using a variance adaptor, a duration, pitch, and energy in to the sequence of speech sounds to obtain the synthetic speech utterances. In some embodiments, the text to speech model controls the language, the accent, and the duration of speech of the vocabulary of words and sentences. The server 106 is configured to modify lip movements that are originally present in the driving face video corresponding to the synthetic speech utterances. In some embodiments, the lip movements are modified by (i) detecting mouth movements from the features of the video, (ii) aligning each synthetic speech utterance with a region in the driving face video with the mouth movements to determine an aligned utterance, (iii) padding the aligned utterance with a silence region of the input speech, and (iv) unchanging regions in the driving face video if the mouth movements are zero in all frames of the driving face video. The input speech may include voice region, non-voice region, and the silence region.

In some embodiments, the server 106 is configured to detect lip-landmarks and a rate of change of the lip-landmarks between a predefined threshold of frames to detect the mouth movements in the video. The server 106 is configured to generate synthetic talking head video based on the lip movements that are modified corresponding to the synthetic speech utterances using the machine learning model. The server 106 is configured to generate a synthetic talking head videos database based on the synthetic talking head video that is generated.

In some embodiments, the server 106 implements a talking face video generator framework for generating lip-synced talking faces to a guiding speech. The talking face video generator framework may be any of a Wav2Lip, a Disentangled Audio Video System (DAVS), a Pose Controllable Audio Visual System (PC-AVS), or a Hierarchical Cross-modal Talking Face Generation with Dynamic Pixel-wise Loss (ATVGnet).

The server 106 is configured to train a user in lip reading using the synthetic talking head videos database. The training of the user includes (i) the lip reading of isolated words, (ii) the lip reading of missing words in sentences, and (iii) the lip reading of the sentences with a context.

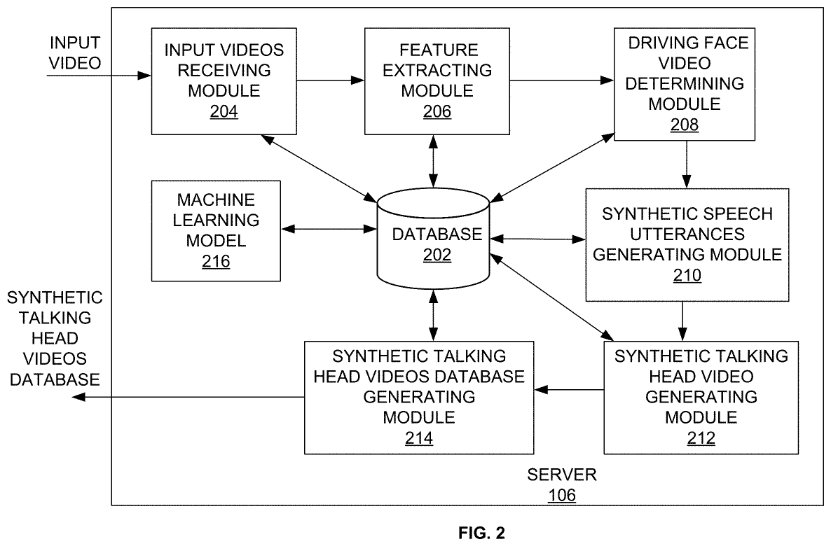

FIG. 2 is a block diagram of the server 106 of FIG. 1 according to some embodiments herein. The server 106 includes a database 202, an input videos receiving module 204, a feature extracting module 206, a driving face video determining module 208, a synthetic speech utterances generating module 210, a synthetic talking head video generating module 212, a synthetic talking head videos database generating module 214, and the machine learning model 216.

The videos are extracted from the data sources 102A-N. The input videos receiving module 204 receives the videos. The feature extracting module 206 extracts one or more features from each frame of videos. The driving face video determining module 208 analyses the video to determine a driving face video if a number of identities, and faces of speakers are equal to one in all frames of the video using a face-detection model. The driving face video is a video that includes the number of identities, and the faces of speakers as one in each frame. The synthetic speech utterances generating module 210 generates synthetic speech utterances by automatically selecting a vocabulary of words and sentences from the data sources using a text to speech model. The synthetic talking head video generating module 212 modifies lip movements that are originally present in the driving face video corresponding to the synthetic speech utterances by (i) detecting mouth movements from the at least one feature of the at least one video, (ii) aligning each synthetic speech utterance with a region in the driving face video with the mouth movements to determine an aligned utterance, (iii) padding the aligned utterance with silence, and (iv) unchanging regions in the driving face video with no mouth movements. The synthetic talking head video generating module 212 generates a synthetic talking head video based on the lip movements that are modified corresponding to the synthetic speech utterances and retaining a background, camera variations, and head movements that correspond to the video. The synthetic talking head videos database generating module 214 generates a database of synthetic talking head videos to train users in lipreading. The synthetic talking head videos are stored in the database 202.

The machine learning model 216 is trained using historical driving face videos, historical native accents, historical non-native accents, and historical synthetic speech utterances.

In an exemplary embodiment, random videos are first collected from various online sources such as YouTube. These random videos introduce real-world variations a lipreader encounters in real life, such as variations in the head-pose of the speaker, the speaker's distance from the camera (lipreader), the speaker's complexion, and lip structure. These videos are post-processed with a face-detection model to detect valid videos. Valid videos are single-identity front-facing talking head videos with no drastic pose changes. Speech utterances are generated using TTS models on vocabulary curated automatically from online sources.

In an exemplary embodiment, a pair of driving speeches and a face video is selected. To generate lip-synced videos using Wav2Lip, the video and speech utterance length are matched by aligning them and then padding the speech utterance with silence. Naively aligning the speech utterance on the driving video can lead to residual lip movements. Wav2Lip does not modify the lip movements in the driving video in the silent region. As a result, the output contains residual lip movements from the original video. This can confuse and cause distress to the user learning to lipread. The speech utterance on the video region is aligned with lip movements. This way, Wav2Lip naturally modifies the original mouth movements to correct speech-synced mouth movements while keeping the regions with no mouth movements untouched. The lip-landmarks and the rate of change of the lip-landmarks between a predefined threshold of frames are used to detect mouth movements in the face videos. Once the lip movements are detected, the audio is aligned on the detected video region and add silences around the speech.

The aligned speech utterance and the face video are passed through Wav2Lip. Wav2Lip modifies the lip movements in the original video and preserves the original head movements, background, and camera variations, thus the realistic-looking synthetic videos are created in the wild.

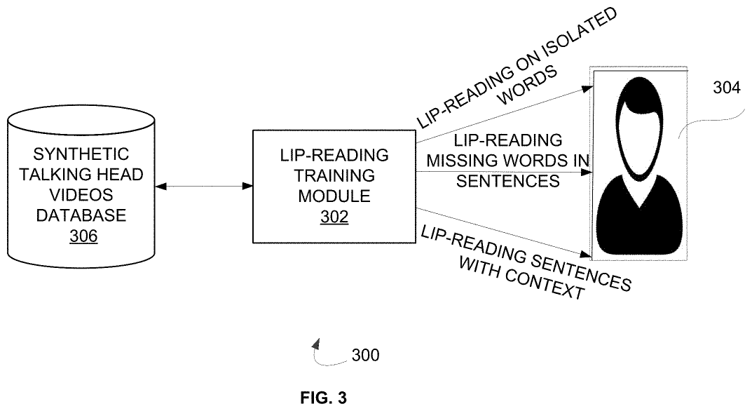

FIG. 3 is an exemplary flow diagram of a method 300 for training a user 304 to lip-read using a synthetic talking head videos database 306 according to some embodiments herein. The method 300 includes training the user 304 in lip reading using a lipreading training module 302. The lipreading training module 302 trains the user 304 based on (i) lip reading on isolated words, (ii) lip reading missing words in sentences, and (iii) lip reading sentences with a context.

The lip reading on isolated words includes presenting the user 304 with a video of an isolated word being spoken by a talking head, along with multiple choices and one correct answer. When the video is played on the screen, the user 304 must respond by selecting a single response from the provided multiple choices. Visually similar words (homophenes) are placed as options in the multiple choices to increase the difficulty of the task. The difficulty can be further increased by testing for difficult words—difficulty associated with the word to lipread, e.g., uncommon words are harder to lipread.

The lip reading missing words in sentences includes presenting the user 304 with a video of sentences spoken by a talking head with a word in the sentence masked. The user 304 is not provided with any additional sentence context. Lip movements are an ambiguous source of information due to the presence of homophenes. This exercise thus aims to use the context of the sentence to disambiguate between multiple possibilities and guess the correct answer. For instance, given the masked sentence “a cat sits on the {masked},” a lipreader can disambiguate between homophenes ‘mat’, ‘bat’, and ‘pat’ using the sentence context to select ‘mat’. The user 304 must enter the input in text format for the masked word. Minor spelling mistakes are accepted.

The lip reading sentences with a context presenting the user 304 with a video of talking heads speaking entire sentences and the context of the sentences. The context acts as an additional cue to the mouthing of sentences and is meant to simulate practical conversations in a given context. The context of the sentences can improve a person's lipreading skills. Context narrows the vocabulary and helps in the disambiguation of different words. The user 304 is evaluated in two contexts—A) Introduction—‘how are you?’, ‘what is your name?’, and B) Lipreading in a restaurant—‘what would you like to order?’. Like WL lipreading, the user 304 is provided with a fixed number of multiple choices and one correct answer. Apart from context, no other information is provided to the user 304 regarding the length or semantics of the sentence.

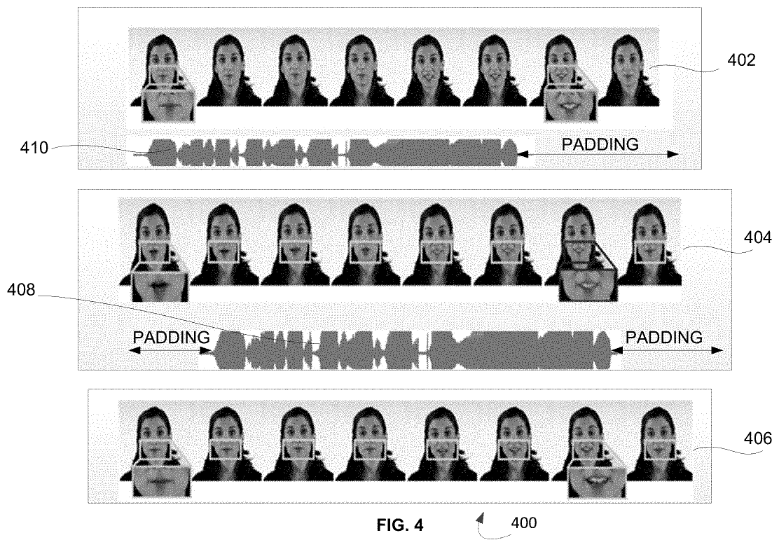

FIG. 4 is an exemplary representation 400 of an original video 402, a misaligned synthetic talking head video 404, and an aligned synthetic talking head video 406 according to some embodiments herein. The exemplary representation 400 of the original video 402 depicts the driving face video of the user 304, lip movements of the user 304 that are originally present in the driving face video at 402, and synthetic speech utterances at 410. The exemplary representation 400 of a misaligned video 404 depicts the driving face video of the user 304, residual lip movements of the user 304 from the original video 402, and the synthetic speech utterances at 408. The exemplary representation 400 of the aligned video 406 depicts the driving face video of the user 304, aligned lip movements of the user 304 from the original video 402 with synthetic speech utterances at 408.

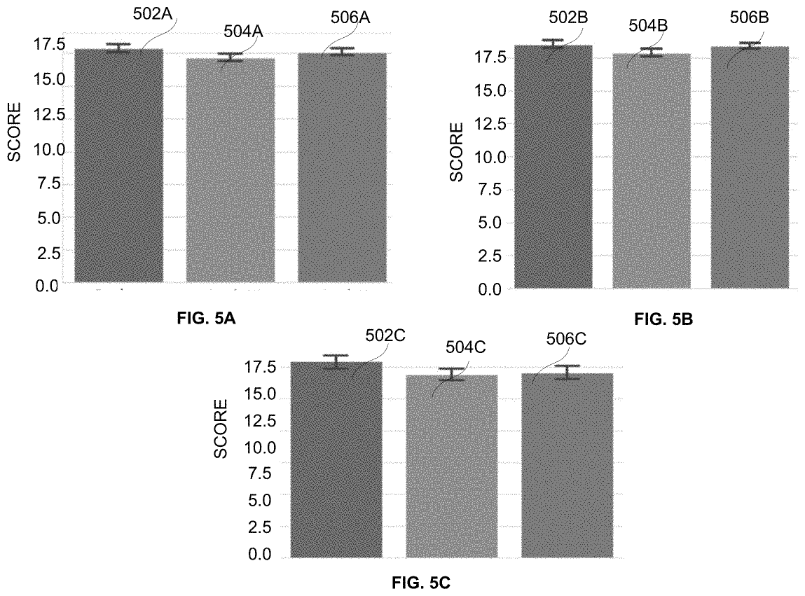

FIGS. 5A-5C are graphical representations of a comparison of scores of users by implementing various lipreading methods according to some embodiments herein. In FIG. 5A, the graphical representation depicts a comparison of scores of users by implementing a word level lipreading training. The graphical representation at 502A depicts a mean performance of the users by implementing the word level lipreading training using a first existing lipreading method. The graphical representation at 504A depicts a mean performance of the users by implementing the word level lipreading training by a second existing lipreading method. The graphical representation at 506A depicts a mean performance of the users by implementing the word level lipreading training by the system 100.

In FIG. 5B, the graphical representation depicts a comparison of scores of users by implementing a sentence level lipreading. The graphical representation at 502B depicts a mean performance of the users by implementing the sentence level lipreading training of the first existing lipreading method. The graphical representation at 504B depicts a mean performance of the users by implementing the sentence level lipreading training of the second existing lipreading method. The graphical representation at 506B depicts a mean performance of the users by implementing the sentence level lipreading training by the system 100.

In FIG. 5C, the graphical representation depicts a comparison of scores of users by implementing missing words in sentences lipreading training. The graphical representation depicts a mean performance of the users by implementing the missing words in sentences lipreading training at 502C using the first existing lipreading method. The graphical representation depicts a mean performance of the users by implementing the missing words in sentences lipreading training at 504C by the second existing lipreading method. The graphical representation depicts a mean performance of the users by implementing the missing words in sentences lipreading training by the system 100 at 506C.

A Bayesian Equivalence Analysis using the Bayesian Estimation Supersedes is implemented to quantify the evidence for the system 100. The mean credible value is computed as the actual difference between the two distributions and the 95% Highest Density Interval (HDI) as the range where the actual difference is with 95% credibility. For the difference in the two distributions to be statistically significant, the difference in the mean scores should lie outside the 95% HDI. The statistics are shown for the first existing lipreading method, the second existing lipreading method and the lipreading method implemented by the system 100 in the following table 1.

TABLE 1

| Lipreading | | | | | |
|---|---|---|---|---|---|
| method | 95% HDI | Mean | MGD | t-value | p-value |
| first existing | (−0.254, 1.63) | 0.701 | 0.706 | 1.676 | 0.103 |
| lipreading method | | | | | |
| second existing | (−0.226, 1.62) | 0.671 | 0.647 | 1.540 | 0.133 |
| lipreading method | | | | | |
| the lipreading | (−0.366, 1.98) | 0.793 | 0.824 | 1.517 | 0.139 |
| method | | | | | |
| implemented by | | | | | |
| the system 100 | | | | | |

The t-value and p-value using the standard two tailed t-test are shown in Table. 1. The statistics lies within the acceptable 95% HDI for all three protocols indicate that the difference in the scores between the two groups is statistically insignificant. The above statistics suggest that the lipreading method implemented by the system 100 is a viable alternative to the existing manually curated talking-head video by the existing lipreading methods.

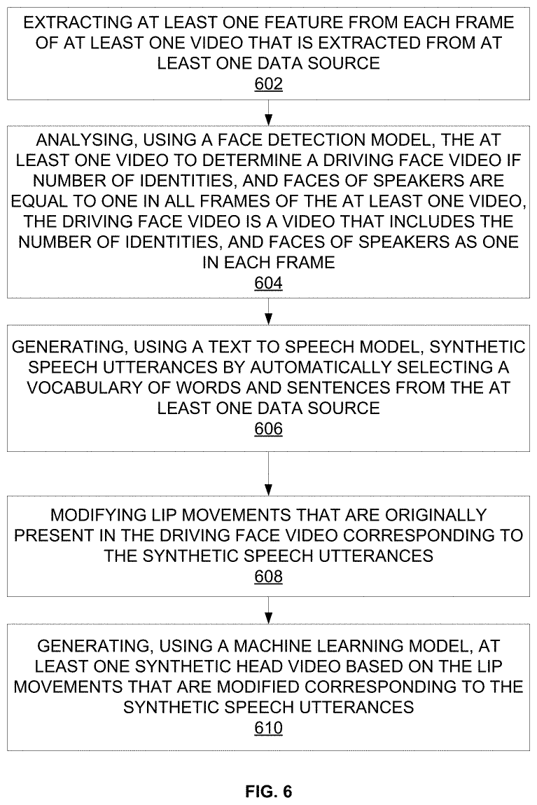

FIG. 6 is a flow diagram that illustrates a method for automatically generating synthetic talking head videos using a machine learning model according to some embodiments herein. At the step 602, the method includes extracting at least one feature from each frame of at least one video that is extracted from at least one data source. At the step 604, the method includes analyzing, using a face-detection model, the at least one video to determine a driving face video if a number of identities, and faces of speakers are equal to one in all frames of the at least one video, the driving face video is a video that includes the number of identities, and the faces of speakers as one in each frame. At the step 606, the method includes generating, using a text to speech model, synthetic speech utterances by automatically selecting a vocabulary of words and sentences from the at least one data source. At the step 608, the method includes modifying lip movements that are originally present in the driving face video corresponding to the synthetic speech utterances. At the step 610, the method includes generating, using machine learning model, at least one synthetic talking head video based on the lip movements that are modified corresponding to the synthetic speech utterances.

In some embodiments, the lip movements are modified by (i) detecting mouth movements from the at least one feature of the at least one video, (ii) aligning each synthetic speech utterance with a region in the driving face video with the mouth movements to determine an aligned utterance, (iii) padding the aligned utterance with a silence region of the input speech, and (iv) unchanging regions in the driving face video if the mouth movements are zero in all frames of the driving face video.

In some embodiments, the method further includes generating a synthetic talking head videos database based on the at least one synthetic talking head video that is generated.

In some embodiments, the method further includes detecting lip-landmarks and a rate of change of the lip-landmarks between a predefined threshold of frames to detect the mouth movements in the at least one video.

In some embodiments, the method further includes training a user in lip reading using the synthetic talking head videos database comprises (i) the lip reading on isolated words, (ii) the lip reading missing words in sentences, and (iii) the lip reading the sentences with a context.

In some embodiments, the at least one feature includes at least one of faces of speakers, head-pose of speaker, back ground, back ground variations, speaker's distance from a camera, lip structures, the lip movements, poses, head movements, camera variations, number of identities, speaker's complexion from a plurality of videos.

In some embodiments, the method further includes training the text to speech model to generate the synthetic speech utterances by (i) obtaining the vocabulary of the words and the sentences that are selected from the at least one of data source, (ii) converting the words and the sentences from the vocabulary to a sequence of sounds, and (iii) adding, using a variance adaptor, a duration, pitch, and energy in to the sequence of speech sounds to obtain the synthetic speech utterances.

In some embodiments, the method further includes detecting, using the face-detection model, the single speaker in the driving face video by (i) tiling a plurality of boxes on each frame of the at least one video with different scales and aspect ratios, (ii) generating a plurality of anchors based on the plurality of boxes that are tiled on each frame of the at least one video, each anchor represents a location of the single speaker, a shape of the single speaker, and a size of the single speaker, and (iii) classifying, using the face detection model, the plurality of anchors by correlating with a series of pre-set anchors to detect the single speaker.

In some embodiments, discarding the at least one video if the face detection model detects multiple speakers or without speakers in the at least one video.

In some embodiments, the method further includes retaining the background, the camera variations, and the head movements that correspond to the at least one video when the at least one synthetic head video is generated.

In some embodiments, the method further includes training the machine learning model using historical driving face videos, historical native accents, historical non-native accents, and historical synthetic speech utterances.

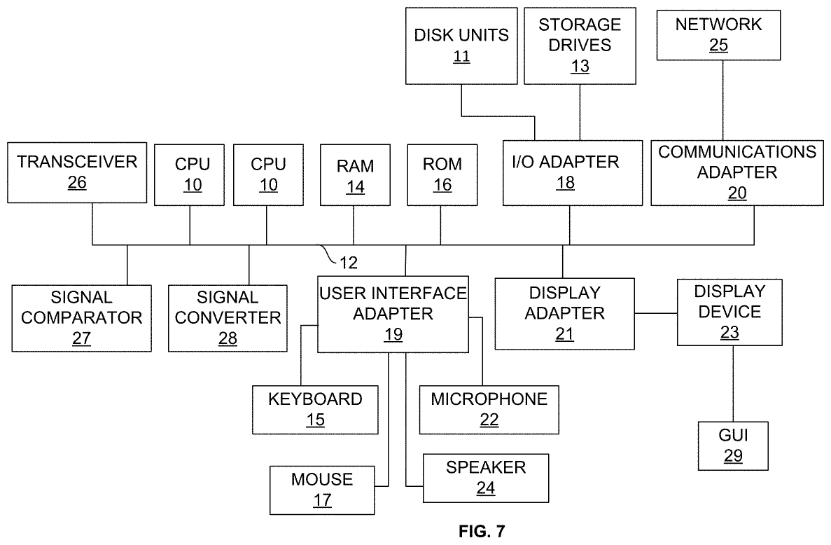

A representative hardware environment for practicing the embodiments herein is depicted in FIG. 7, with reference to FIGS. 1 through 6. This schematic drawing illustrates a hardware configuration of a server 106/computer system/computing device in accordance with the embodiments herein. The system includes at least one processing device CPU 10 and at least one graphical processing device GPU 38 that may be interconnected via system bus 14 to various devices such as a random access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for automatically generating at least one synthetic talking head video using a machine learning model comprising;
extracting at least one feature from each frame of at least one video that is extracted from at least one data source;
analysing, using a face-detection model, the at least one feature to determine a driving face video if a number of identities, and faces of speakers are equal to one in all frames of the at least one video, wherein the driving face video is a video that comprises the number of identities, and the faces of speakers as one in each frame;
generating, using a text to speech model, synthetic speech utterances by automatically selecting a vocabulary of words and sentences from the at least one data source;
modifying lip movements of the single speaker that are originally present in the driving face video corresponding to the synthetic speech utterances; and
generating, using the machine learning model, the at least one synthetic talking head video based on the lip movements that are modified corresponding to the synthetic speech utterances.

2. The processor-implemented method of claim 1, wherein the lip movements are modified by
detecting mouth movements from the at least one feature of the at least one video;
aligning each synthetic speech utterance with a region in the driving face video with the mouth movements to determine an aligned utterance;
padding the aligned utterance with a silence region of the input speech; and
unchanging regions in the driving face video if the mouth movements are zero in all frames of the driving face video.

3. The processor-implemented method of claim 1, further comprising generating a synthetic talking head videos database based on the at least one synthetic talking head video that is generated.

4. The processor-implemented method of claim 2, further comprising detecting lip-landmarks and a rate of change of the lip-landmarks between a predefined threshold of frames to detect the mouth movements in the at least one video.

5. The processor-implemented method of claim 3, further comprising training a user in lip reading using the synthetic talking head videos database comprises (i) the lip reading on isolated words, (ii) the lip reading missing words in sentences, and (iii) the lip reading the sentences with a context.

6. The processor-implemented method of claim 1, wherein the at least one feature comprises at least one of faces of speakers, head-pose of speaker, back ground, back ground variations, speaker's distance from a camera, lip structures, the lip movements, poses, head movements, camera variations, number of identities, speaker's complexion from a plurality of videos.

7. The processor-implemented method of claim 1, further comprising training the text to speech model to generate the synthetic speech utterances by
obtaining the vocabulary of the words and the sentences that are selected from the at least one of data source;
converting the words and the sentences from the vocabulary to a sequence of sounds; and
adding, using a variance adaptor, a duration, pitch, and energy in to the sequence of speech sounds to obtain the synthetic speech utterances.

8. The processor-implemented method of claim 1, further comprising detecting, using the face-detection model, the single speaker in the driving face video by
tiling a plurality of boxes on each frame of the at least one video with different scales and aspect ratios;
generating a plurality of anchors based on the plurality of boxes that are tiled on each frame of the at least one video, wherein each anchor represents a location of the single speaker, a shape of the single speaker, and a size of the single speaker; and
classifying, using the face detection model, the plurality of anchors by correlating with a series of pre-set anchors to detect the single speaker.

9. The processor-implemented method of claim 1, further comprising discarding the at least one video if the face detection model detects multiple speakers or without speakers in the at least one video.

10. The processor-implemented method of claim 1, further comprising retaining the background, the camera variations, and the head movements that correspond to the at least one video when the at least one synthetic head video is generated.

11. The processor-implemented method of claim 1, further comprising training the machine learning model using historical driving face videos, historical native accents, historical non-native accents, and historical synthetic speech utterances.

12. A system for automatically generating at least one synthetic talking head video using a machine learning model comprising:
a device processor; and
a non-transitory computer-readable storage medium storing one or more sequences of instructions, which when executed by the device processor, causes:
extracting at least one feature from each frame of at least one video that is extracted from at least one data source;
analysing, using a face-detection model, the at least one feature to determine a driving face video if a number of identities, and faces of speakers are equal to one in all frames of the at least one video, wherein the driving face video is a video that comprises the number of identities, and the faces of speakers as one in each frame;
generating, using a text to speech model, synthetic speech utterances by automatically selecting a vocabulary of words and sentences from the at least one data source;
modifying lip movements of the single speaker that are originally present in the driving face video corresponding to the synthetic speech utterances; and
generating, using the machine learning model, the at least one synthetic talking head video based on the lip movements that are modified corresponding to the synthetic speech utterances.

13. One or more non-transitory computer-readable storage medium storing the one or more sequence of instructions, which when executed by the one or more processors, causes to perform a method for automatically generating at least one synthetic talking head video using a machine learning model, the method comprising;
extracting at least one feature from each frame of at least one video that is extracted from at least one data source;
analysing, using a face-detection model, the at least one feature to determine a driving face video if a number of identities, and faces of speakers are equal to one in all frames of the at least one video, wherein the driving face video is a video that comprises the number of identities, and the faces of speakers as one in each frame;
generating, using a text to speech model, synthetic speech utterances by automatically selecting a vocabulary of words and sentences from the at least one data source;
modifying lip movements of the single speaker that are originally present in the driving face video corresponding to the synthetic speech utterances; and
generating, using the machine learning model, the at least one synthetic talking head video based on the lip movements that are modified corresponding to the synthetic speech utterances.

14. The system of claim 12, wherein the lip movements are modified by
detecting mouth movements from the at least one feature of the at least one video;
aligning each synthetic speech utterance with a region in the driving face video with the mouth movements to determine an aligned utterance;
padding the aligned utterance with a silence region of the input speech; and
unchanging regions in the driving face video if the mouth movements are zero in all frames of the driving face video.

15. The system of claim 12, wherein the processor is configured to generate a synthetic talking head videos database based on the at least one synthetic talking head video that is generated.

16. The system of claim 12, wherein the processor is configured to detect lip-landmarks and a rate of change of the lip-landmarks between a predefined threshold of frames to detect the mouth movements in the at least one video.

17. The system of claim 15, wherein the processor is configured to train a user in lip reading using the synthetic talking head videos database comprises (i) the lip reading on isolated words, (ii) the lip reading missing words in sentences, and (iii) the lip reading the sentences with a context.

18. The system of claim 12, wherein the at least one feature comprises at least one of faces of speakers, head-pose of speaker, back ground, back ground variations, speaker's distance from a camera, lip structures, the lip movements, poses, head movements, camera variations, number of identities, speaker's complexion from a plurality of videos.

19. The system of claim 12, wherein the processor is configured to train the text to speech model to generate the synthetic speech utterances by
obtaining the vocabulary of the words and the sentences that are selected from the at least one of data source;
converting the words and the sentences from the vocabulary to a sequence of sounds; and
adding, using a variance adaptor, a duration, pitch, and energy in to the sequence of speech sounds to obtain the synthetic speech utterances.

20. The system of claim 12, wherein the processor is configured to detect, using the face-detection model, the single speaker in the driving face video by
tiling a plurality of boxes on each frame of the at least one video with different scales and aspect ratios;
generating a plurality of anchors based on the plurality of boxes that are tiled on each frame of the at least one video, wherein each anchor represents a location of the single speaker, a shape of the single speaker, and a size of the single speaker; and
classifying, using the face detection model, the plurality of anchors by correlating with a series of pre-set anchors to detect the single speaker.
